(19) United States
(12) Patent Application Publication
(10) Pub. No.: US 2004/0015662 A1
(43) Pub. Date: Jan. 22, 2004

(54) Memory card, memory card controller, and software therefor

(76) Inventor: Aron Cummings, Pullman, WA (US)

Correspondence Address: HEWLETT-PACKARD COMPANY, Intellectual Property Administration, P.O. Box 272400, Fort Collins, CO, 80527-2400, US

(21) Appl. No.: 10/199,032

(22) Filed: Jul. 22, 2002

(51) Int. Cl. G06F 12/00

(52) U.S. Cl. 711/154; 711/170

(57) ABSTRACT

A memory card, memory card controller, program product and method, the method comprising machine readable program code for causing a machine to perform the following method steps: determining the size of a received file to be stored in a memory; comparing the determined file size to an available memory capacity and determining if a first criterion is met; if the first criterion is met, then automatically compressing at least one existing stored file in the memory or the received file to be stored.

### FIELD OF THE INVENTION

Present invention relates generally to the field of memories, and more particularly to storage operations in a memory card.

### BACKGROUND OF THE INVENTION

The inefficient use of memory card storage space is frequently a problem, particularly with regard to portable appliances such as MP3 players and cameras. The present invention is directed to facilitating efficient storage on a memory card.

### SUMMARY OF THE INVENTION

A program product for a memory card controller is provided in ohe embodiment of the present invention, comprising machine readable program code for causing a machine to perform the following method steps: determining the size of a received file to be stored in a memory; comparing the determined file size to an available memory capacity and determining if a first criterion is met; if the first criterion is met, then automatically compressing at least one existing stored file in the memory or the received file to be stored.

In a further embodiment of the present invention, a program product for a memory card controller is provided, comprising machine readable program code for causing a machine to perform the following method steps: determining the size of a received file to be stored in a memory; comparing the determined file size to an available memory capacity and determining if a first criterion is met; if the first criterion is met, then automatically selecting for compression at least one existing stored file in the memory or the received file to be stored based on a second criterion.

In a yet further embodiment of the present invention, a method for controlling storage in a memory is provided, comprising the steps: determining the size of a received file to be stored in a memory; comparing the determined file size to an available memory capacity and determining if a first criterion is met; if the first criterion is met, then automatically compressing at least one existing stored file in the memory or the received file to be stored.

In a yet further embodiment of the present invention, a memory controller is provided comprising: a component for determining the size of a received file to be stored in a memory; a component for comparing the determined file size to an available memory capacity and determining if a first criterion is met; a component for, if the first criterion is met, automatically compressing at least one existing stored file in the memory or the received file to be stored.

In a further embodiment of the present invention, a portable memory card comprising: a memory controller on the card; a component in the memory controller for determining the size of a received file to be stored in a memory; a component in the memory controller for comparing the determined file size to an available memory capacity and determining if a first criterion is met; a component in the memory controller for, if the first criterion is met, automatically compressing at least one existing stored file in the memory or the received file to be stored.

In a further embodiment of the present invention, a memory card is provided, comprising: a memory controller on the card; a component on the card for determining the size of a received file to be stored in a memory; a component on the card for comparing the determined file size to an available memory capacity and determining if a first criterion is met; a component on the card for, if the first criterion is met, automatically selecting for compression at least one existing stored file in the memory or the received file to be stored based on a second criterion.

### BRIEF DESCRIPTION OF THE DRAWINGS

FIG. 1 is a schematic block diagram of a memory card in accordance with an embodiment of the present invention.

FIG. 2 is a block diagram of a flowchart of operations which may be followed by a memory card controller in accordance with the present invention.

FIG. 3 is a block diagram providing a flowchart of operations which may be followed by a memory card controller in a further embodiment of the present invention.

### DETAILED DESCRIPTION OF THE EMBODIMENTS

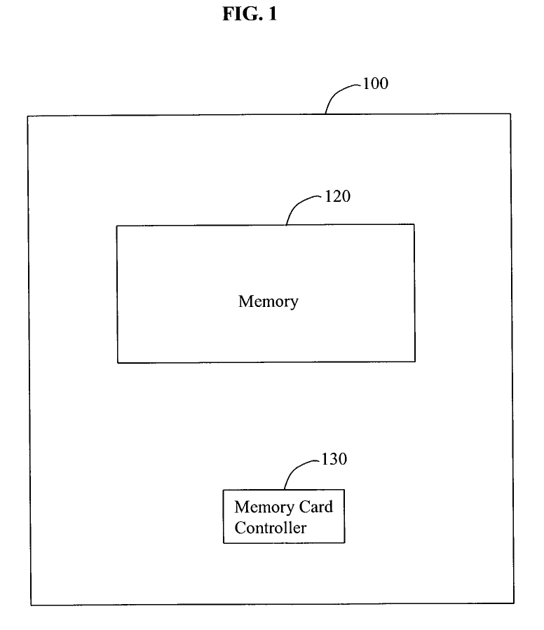

Referring now to FIG. 1, there is shown a memory card 100 in accordance with an embodiment of the present invention. The memory card 100 includes a memory 120 and a memory card controller 130. It should be noted that although the present invention is explained in the context of an embodiment of a memory card, the implementation of the program product and method of the present invention could also be used in a memory controller or other controlling device for any appliance that utilizes a memory. The memory 120 can be implemented by any memory structure including optical, magnetic, and electrical memory structure. The memory card controller 130 may be implemented by a microcomputer or other appropriate processing device. The present invention is not limited by the type of memory or the type of memory card controller utilized.

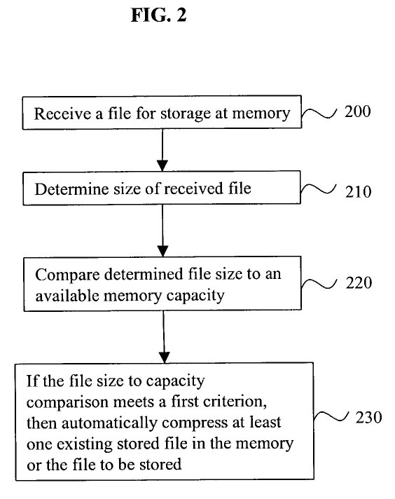

Referring now to FIG. 2, there is shown a block diagram of an embodiment of a method and program product which may be utilized with the memory controller and memory card of the present invention. Referring now to FIG. 2, block 200 represents the receipt of a file for storage in the memory 120. This receiving operation may take place either on the memory card itself or external to the memory card. It may include the loading of the file into a buffer and logic for determining that the file has been received at the buffer.

In block 210, the size of the received files is determined.

In block 220 the size of the file determined in block 210 is compared to an available memory capacity for the memory 120. If the file size to capacity comparison meets a first criterion, then a compression is automatically performed on one or more existing stored files in the memory 120 or on the file to be stored.

In one embodiment of the present invention, only existing files will be compressed, and not the received file to be stored.

In one embodiment, the first criterion is whether the file size exceeds an available memory capacity. If the received file does exceed the available memory capacity, then the compressing step comprises selecting at least one existing stored file or the received file to be stored to compress based at least in part on a second criteria. In an embodiment, the second criterion is whether the bit rate for the file exceeds a predetermined bit rate. This criterion is applied advantageously because it has been found that for some types of content such as music, a minimum bit rate is required to avoid compressing a file to the point of poor quality sound. By way of example but not by way of limitation, such a minimum bit rate could be 128 k bits/seconds.

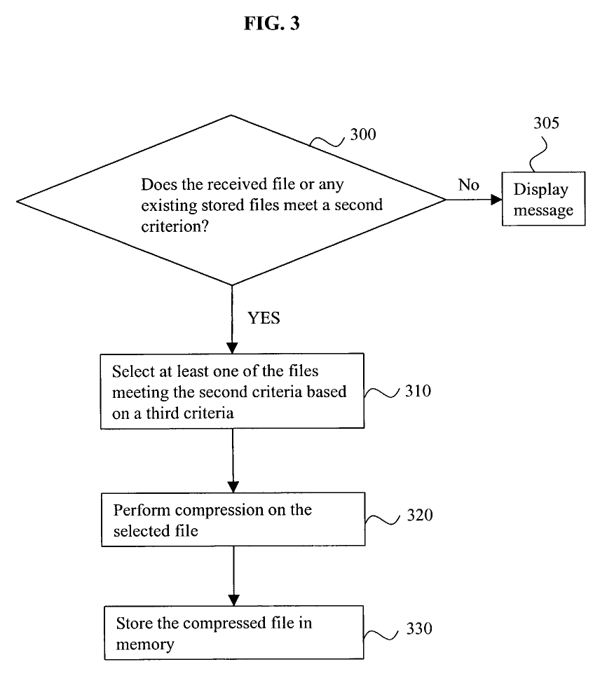

Referring to FIG. 3, block 300 represents the determination of whether the received file or any existing stored files meet the second criteria. If none of the files meet the second criterion, then the operation moves to block 305. Block 305 may either display an over capacity message or other error message to the user, or may provide the user the option of compressing below the minimum bit rate, or the option of overriding existing stored files in order to store the received files.

In block 310, if there are a plurality of files that meet the second criterion, then a selection of one of these files may be made either randomly, or based on a third criterion. By way of example but not by way of limitation, the third criterion may comprise whether the file size exceeds a predetermined amount.

Referring to block 320, a compression algorithm is then performed on the selected file. The compressed file resulting from this compression operation is then stored in the memory in block 330. The method and program products of the present invention may be implemented in a memory controller on a memory card or on a memory card controller external to the memory card. The present invention is particularly advantageous for use with music. When a user attempts to add a song to a memory card, but the song file will not fit on the memory card, then the card would automatically compress one or more of the existing stored files on the card or the new file until the new file would fit on the memory card. Note that the present invention is not limited to music data. Additionally, note that the minimum bit rate of the second criteria may vary depending on the type of data to be stored. It should also be noted that there are various other third criterion which make be utilized to select files which meet the second criteria for compression.

The foregoing description of an embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A program product for a memory card controller, comprising machine readable program code for causing a machine to perform the following method steps:
determining the size of a received file to be stored in a memory;
comparing the determined file size to an available memory capacity and determining if a first criterion is met;
if the first criterion is met, then automatically compressing at least one existing stored file in the memory or the received file to be stored.

2. The program product as defined in claim 1, wherein only an existing file in the memory is compressed.

3. The program product as defined in claim 1, wherein the first criterion is whether the file size exceeds an available memory capacity.

4. The program product as defined in claim 1, wherein the compressing step comprises selecting at least one existing stored file or the received file to be stored to compress based at least in part on a second criterion.

5. The program product as defined in claim 4, wherein the second criterion is whether a bit rate for the file exceeds a predetermined bit rate.

6. The program product as defined in claim 4, wherein the compressing step comprises selecting at least one existing stored file or the received file to be stored to compress based at least in part on a third criterion.

7. The program product as defined in claim 6, wherein the third criterion is whether the file size exceeds a predetermined amount.

8. A program product for a memory card controller, comprising machine readable program code for causing a machine to perform the following method steps:
determining the size of a received file to be stored in a memory;
comparing the determined file size to an available memory capacity and determining if a first criterion is met;
if the first criterion is met, then automatically selecting for compression at least one existing stored file in the memory or the received file to be stored based on a second criterion.

9. The program product as defined in claim 8, wherein the first criterion is whether the file size exceeds an available memory capacity.

10. The program product as defined in claim 9, wherein the second criterion is whether the bit rate for the existing stored file exceeds a predetermined bit rate.

11. The program product as defined in claim 10, wherein the compressing step comprises selecting at least one existing stored file or the received file to be stored to compress based at least in part on a third criterion.

12. The program product as defined in claim 11, wherein the third criterion is whether the file size exceeds a predetermined amount.

13. A method for controlling storage in a memory comprising the steps:
determining the size of a received file to be stored in a memory;
comparing the determined file size to an available memory capacity and determining if a first criterion is met;
if the first criterion is met, then automatically compressing at least one existing stored file in the memory or the received file to be stored.

14. The method as defined in claim 13, wherein the first criterion is whether the file size exceeds an available memory capacity.

15. The method as defined in claim 14, wherein the compressing step comprises selecting at least one existing stored file or the received file to be stored to compress based at least in part on a second criterion.

16. The method as defined in claim 15, wherein the second criterion is whether a bit rate for the file exceeds a predetermined bit rate.

17. The method as defined in claim 16, wherein the compressing step comprises selecting at least one existing stored file or the received file to be stored to compress based at least in part on a third criterion.

18. A memory controller comprising:
a component for determining the size of a received file to be stored in a memory;
a component for comparing the determined file size to an available memory capacity and determining if a first criterion is met;
a component for, if the first criterion is met, automatically compressing at least one existing stored file in the memory or the received file to be stored.

19. A portable memory card comprising:
a memory controller on the card;
a component in the memory controller for determining the size of a received file to be stored in a memory;
a component in the memory controller for comparing the determined file size to an available memory capacity and determining if a first criterion is met;
a component in the memory controller for, if the first criterion is met, automatically compressing at least one existing stored file in the memory or the received file to be stored.

20. The memory card as defined in claim 19, wherein the first criterion is whether the file size exceeds an available memory capacity.

21. The memory card as defined in claim 20, wherein the compressing step comprises selecting at least one existing stored file or the received file to be stored to compress based at least in part on a second criterion.

22. The memory card as defined in claim 21, wherein the second criterion is whether a bit rate for the file exceeds a predetermined bit rate.

23. The memory card as defined in claim 22, wherein the compressing step comprises selecting at least one existing stored file or the received file to be stored to compress based at least in part on a third criterion.

24. The memory card as defined in claim 23, wherein the third criterion is whether the file size exceeds a predetermined amount.

25. A memory card, comprising:
a memory controller on the card;
a component on the card for determining the size of a received file to be stored in a memory;
a component on the card for comparing the determined file size to an available memory capacity and determining if a first criterion is met;
a component on the card for, if the first criterion is met, automatically selecting for compression at least one existing stored file in the memory or the received file to be stored based on a second criterion.
